(19) United States
(12) Patent Application Publication
(10) Pub. No.: US 2019/0108601 A1
(43) Pub. Date: Apr. 11, 2019

(54) SYSTEMS, METHODS, AND DEVICES FOR RAPID REORDERING

(71) Applicant: TACO BELL CORP., Irvine, CA (US)

(72) Inventors: Tony Ke, New York, NY (US); Veronica Luna, Anaheim, CA (US); John Wesley Cybulski, Huntington Beach, CA (US); Colin Andrew Howarth, Pacifica, CA (US); Brian Michael Peters, Seattle, WA (US); Ralph Zenger, Irvine, CA (US); Derrick Chan, Tustin, CA (US)

(21) Appl. No.: 16/156,822

(22) Filed: Oct. 10, 2018

Related U.S. Application Data
(63) Continuation-in-part of application No. 14/774,670, filed on Sep. 10, 2015, now abandoned.
(60) Provisional application No. 61/778,186, filed on Mar. 12, 2013.
(60) Provisional application No. 62/620,242, filed on Jan. 22, 2018.

(51) Int. Cl. G06Q 50/12; G06Q 30/06

(52) U.S. Cl. CPC G06Q 50/12; G06Q 30/0641; G06Q 30/0635

(57) ABSTRACT

Rapid reordering may be performed by a two-step process. A user interface may present a user with a first user interface control, which can be a button or other user interface control that enables a user interface to initiate an express reorder of a previously-ordered item. Once the user has selected the button, the user interface can present default details about the order along with a second user interface control, which can be a swipe bar or another button (or some other control). User selection of the second user interface control can complete the reorder process. Although described with respect to reordering, this two-step process can also be used for ordering items not previously ordered by a user before.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57.

### BACKGROUND

With the development of mobile devices and other computing systems, it is now possible to place an order for items and services direct from a mobile device or other computing system. For example, it is now possible to order food items at a restaurant using a mobile device. In general, mobile devices and other computing systems have made it easier to locate items for purchase, as well as to order the item of interest. No longer must a consumer flip through page after page of a physical catalog or a menu in order to identify the service or good of interest.

Software applications operating on a mobile device or other computing system have allowed consumers to search directly for the products and services consumers want. By making it easier to locate and purchase services and goods, companies can increase the number of sale transactions. Accordingly, it can be advantageous to provide a system to consumers that make the process of locating and/or purchasing goods and services more efficient and effective, because such improvements can increase the number of sale transactions that a company can realize.

### SUMMARY OF SOME EMBODIMENTS

Some embodiments include a portable computing device, comprising: a display; a memory storing an application program; and a processor executing the application program to: cause presentation, on the display, of a plurality of orders of restaurant menu items previously ordered by a user; receive, from the portable computing device, a selection by the user of one of the orders, the selection indicating an intent of the user to reorder the selected order; receive a swipe input from the user corresponding to the user swiping across the display, the swipe confirming the user's intent to reorder the selected order; in response to receiving the swipe input, reorder the selected order by automatically communicating the selected order over a network to a remote server operable to forward the selected order to a restaurant.

In some embodiments, the portable computing device of the preceding paragraph can include a combination or sub-combination of features. The processor can be further configured to cause presentation on the display of a carousel user interface control configured to enable the user to swipe between the plurality of orders and to perform the selection of the selected order. The processor can be further configured to cause presentation on the display of an express reorder button superimposed over the carousel, the express reorder button being user-selectable to enable the user to initiate the reorder of the selected order. The processor can be further configured to output a first user interface comprising the plurality of orders and to output a second user interface comprising the selected order in response to receiving, from the portable computing device, the selection. The second user interface can include a swipe user interface control that receives the swipe input from the user. The second user interface can include one or more images of restaurant menu items in the selected order, default order details, and the swipe user interface control below the one or more images and below the default order details. The default order details can include a pickup restaurant and a pickup location in the restaurant. The pickup restaurant can be automatically selected as a previous restaurant visited by the user if the user is within a certain range of the previous restaurant. The pickup restaurant can be automatically selected as a closest restaurant to the user if the user is outside the certain range of the previous restaurant. The one or more images can include a plurality of images horizontally laid out on the display, and wherein the display comprises an option to expand the plurality of images into a vertical list comprising the plurality of images vertically laid out on the display along with a number depicted next to each of the images and text describing each of the images.

Some embodiments include a method, comprising: under control of a hardware processor in a mobile device, causing presentation, on a display of the mobile device, a plurality of previous sets of restaurant menu items previously ordered by a user; receiving, from the mobile device, a first selection of a first restaurant menu item from the previous sets of restaurant menu items previously ordered by the user; receiving a swipe input from the user corresponding to the user swiping across the display of the mobile device; and in response to receiving the swipe input, placing an order for the first restaurant menu item by automatically communicating the order over a network so that the order is forwarded to a restaurant.

In some embodiments, the method of the preceding paragraph can include a combination or sub-combination of features. The method can further include causing presentation on the display of an express reorder button, the express reorder button user-selectable to enable the user to provide the first selection of the first set of restaurant menu items. The method can further include outputting a first user interface comprising the first set of restaurant menu items previously ordered by a user and outputting a second user interface in response to receiving, from the portable computing device, the first selection of the first set of restaurant menu items. The second user interface can include a swipe user interface control that receives the swipe input from the user. The second user interface can include an image of the first set of restaurant menu items, default order details, and the swipe user interface control below the first set of restaurant menu items and the default order details. The default order details can include a pickup restaurant and a pickup location in the restaurant. The pickup restaurant can be automatically selected as a previous restaurant visited by the user if the user is within a certain range of the previous restaurant or as a closest restaurant to the user if the user is outside the certain range of the previous restaurant. The first set of restaurant menu items can be depicted in pictures horizontally laid out on the display, and wherein the display comprises an option to expand the first set of restaurant items into a vertical list showing the pictures vertically aligned, a number of each item, and text describing each item.

Some embodiments include a non-transitory physical computer storage comprising computer executable instructions stored thereon that, when executed by a hardware processor, configure the hardware processor to perform operations comprising: causing presentation, on a screen of the mobile device, a set of restaurant menu items previously ordered by a user; receiving an input from the user corresponding to the user swiping across a screen of the mobile device; and in response to receiving the input from the user corresponding to the user swiping across a screen of the mobile device, placing an order for the set of restaurant menu items by communicating the order to a restaurant over a network.

In some embodiments, the non-transitory physical computer storage of the preceding paragraph can include a combination or sub-combination of features. The operations can further include automatically selecting the restaurant based on a geographic proximity of the mobile device to the restaurant. The operations can further include causing presentation of default order details, wherein the default order details comprise a pickup restaurant and a pickup location in the restaurant. The pickup restaurant can be automatically selected as a previous restaurant visited by the user if the user is within a certain range of the previous restaurant or as a closest restaurant to the user if the user is outside the certain range of the previous restaurant. The set of restaurant menu items can be depicted in pictures horizontally laid out on the screen, and wherein the screen comprises an option to expand the set of restaurant items into a vertical list showing the pictures vertically aligned, a number of each item, and text describing each item.

Advancements in the technology for mobile devices and other computing systems make it possible to improve the efficiency and effectiveness of locating and/or purchasing goods and services from a company.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### BRIEF DESCRIPTION OF THE DRAWINGS

The foregoing and other features, aspects, and advantages of the embodiments of the invention are described in detail below with reference to the drawings of various embodiments, which are intended to illustrate and not to limit the embodiments of the invention. The drawings comprise the following figures in which:

FIG. 1 depicts an embodiment of a schematic diagram illustrating a computing device displaying an ordering system.

FIGS. 2A, 2B, 2C, and 2D depict an embodiment of a schematic diagram illustrating a user placing an order by using the ordering system on a computing device.

FIG. 3 depicts a block diagram depicting a high-level overview of an embodiment of a rotation-based ordering system.

FIGS. 4A, 4B, and 4C depict a flow chart depicting an embodiment of a process for a rotation-based ordering system.

FIG. 5 depicts a flow chart depicting an embodiment of a process for a rotation-based ordering system.

FIG. 6 depicts a flow chart depicting an embodiment of a process for a rotation-based ordering system.

FIG. 7 depicts a block diagram depicting an embodiment of a computer system configured to run software for implementing one or more embodiments of the rotation-based ordering systems described herein.

FIGS. 8, 9, 10, 11, 12, 13, 14, and 15 depict example user interfaces for reordering items, such as items at a restaurant.

FIG. 16 depicts an example swipe based express reorder process 1600.

### DETAILED DESCRIPTION OF EXAMPLE EMBODIMENTS

### Introduction

Although several embodiments, examples and illustrations are disclosed below, it will be understood by those of ordinary skill in the art that the invention described herein extends beyond the specifically disclosed embodiments, examples and illustrations and includes other uses of the invention and obvious modifications and equivalents thereof. Embodiments of the invention are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention. In addition, embodiments of the invention can comprise several novel features and no single feature is solely responsible for its desirable attributes or is essential to practicing the inventions herein described.

In many instances, a consumer often orders the same items when entering a particular store. For example, many people will order a taco and a soda when entering a restaurant. Furthermore, it is increasingly common to order goods and services through a mobile phone or other computing device. In placing an order using a mobile device or other computing system, a consumer that often orders the same items will generally have to select each item from the menu in order to place the order for items that the user often orders. The foregoing scenario not only plays itself out in the food industry, but also this scenario is fairly commonplace in the context of prescription drugs, office supplies, groceries, monthly bill payment, consumer products, and the like. Accordingly, there is a need for a system to simplify the reordering process.

The development of mobile devices, such as smartphones and tablet computers and laptops, have made it easier for the consuming public to locate and/or purchase goods and/or services from sellers. For example, a user can utilize a mobile device to access a menu of a restaurant. By utilizing the menu of the restaurant, the user can determine what food products to purchase and/or place an order for such food products. The challenge in utilizing mobile devices and other computing systems to place an order for goods and/or services is, generally these mobile devices and other computing systems do not allow for a user to place an order for items that are repeatedly ordered without having to type in all of the necessary information for completing the order.

Accordingly, in order to complete an order for repeatedly ordered items, a user must generally locate the repeatedly ordered item or service in a menu or a catalog, and then perhaps enter payment information and shipping information. Additionally, the laborious task of entering a repeat order can be a barrier for some consumers to place an order. Accordingly, it would be advantageous for increasing sales of repeat customers to utilize a system that employs a novel and easy mechanism for entering a repeat order.

It would be advantageous to configure a mobile device or other computing system to allow for ordering of repeat or previously placed orders that are commonly made by a consumer. However, the challenge in creating such a system is that generally, the display size of mobile devices and other computing systems have limited screen size for displaying data. Generally, the display of previously placed orders requires a display area sufficiently large to provide such information to a user. To solve this challenge, the systems and methods disclosed herein provide for a rotation-based ordering system.

In an embodiment, a purchase ordering system enables a user to rotate a mobile device from a vertical orientation to a horizontal orientation (or vice versa), whereby the mobile device is configured to display one or more previously ordered items or orders from which the user can select to reorder. For example, a user could use such a system in order to place an order for food at a restaurant by simply rotating the mobile device from a vertical orientation to a horizontal orientation which causes the mobile phone to display previously placed food orders.

In an embodiment, the system can be configured to allow a user to quickly order a repeat item by simply rotating the mobile device or other computing system of the user to a horizontal orientation. In an embodiment, the system can be configured to allow a consumer to rotate the mobile device of the user in order to re-order. By positioning the mobile device or other computing system in a horizontal orientation, the system can be configured to enter into an alternative display state. In the alternative display state, the system can change the display to show information for previously placed orders. In other words, by rotating the mobile device or other computing system to a horizontal orientation, the system can remove the existing contents on the display and display only previous orders in a horizontal direction. In an alternative embodiment, by positioning the mobile device or other computing system in a horizontal orientation, the system can be configured to reorient the contents for correctly displaying the content in a horizontal orientation, thereby increasing the amount of display area for presenting data to a user, from the perspective of margin width. In other words, by rotating the mobile device or other computing system to a horizontal orientation, the system can display additional data in a horizontal direction. In such an embodiment, the added display area in a horizontal direction can allow the system to show the necessary information for previously placed orders along with the content selected in the vertical orientation.

The rotation-based ordering systems disclosed herein can further be advantageous because they provide a simple and novel way for a user to place an order that has been previously placed in the past. Typically, a user would have to re-enter a previously placed order item manually in order to place the order. Then, a user would have to hit a “submit” or “place order” button.

By utilizing the systems disclosed herein, a user need not manually enter in a previously placed order. Rather, the user would only need to rotate the user's mobile device or other computer system into a horizontal orientation. By placing the mobile device or other computer system in a horizontal orientation, the system can be configured to display previously placed orders. Optionally, the system can be configured to display previously provided payment information, such that the user need not manually enter such information into the system again. Additionally, the system can be optionally configured to display previously selected store, restaurant or other fulfillment entity information, such that the user need not enter such information manually. The foregoing information can all be displayed on a user's mobile device or other computing system by simply rotating the user's mobile device or other computing system from a vertical position to a horizontal position or a substantially horizontal position.

In an embodiment, the terms “horizontal position,” “horizontal orientation,” “substantially horizontal position” as used herein are interchangeable terms and refer to when the mobile device or other computing system is positioned horizontally or is positioned at about 80°-100° from the vertical axis of the mobile device that is parallel to the direction of the force of gravity. The foregoing tolerance range for determining a substantially horizontal orientation can vary without deviating from the spirit of the embodiments disclosed herein, for example, the tolerance range can be 75°-105°, or 70°-110°, or the like. The rotation-based ordering systems disclosed herein can be utilized in a variety of software applications and purchasing contexts.

For example, the rotation-based ordering systems disclosed herein can be used in a mobile application context. In an embodiment, a user can download a mobile application onto the mobile device of the user. The mobile application can be configured to allow the user to order food items from a particular restaurant. The user can activate the mobile application by clicking the icon on the mobile device. When the mobile application has been launched, the user immediately sees a “home” screen for the mobile application.

In an embodiment, the “home” screen can display a traditional menu of available food products for purchase. Typically, the user will activate the mobile application while the phone is in a vertical position or portrait orientation. While in the portrait orientation, the user can scroll through the menu to peruse the various food items available for consumption. The mobile application can be configured with one or more of the rotation-based ordering systems disclosed herein. Accordingly, the rotation-based ordering system can be configured to detect when the user has rotated the user's mobile device from a vertical position or portrait orientation to a horizontal position or landscape orientation.

By positioning the mobile device in a horizontal position or landscape orientation, the rotation-based ordering system can be activated to display previously placed orders that the user has purchased in the past. In one embodiment, as described above, by positioning the device in the horizontal orientation or landscape orientation, the system can remove the existing contents on the display and display only previous orders in the horizontal direction. The content data displayed on the display screen of the mobile device are reoriented such that the content data is correctly displayed right-side-up in the landscape orientation. In an alternative embodiment, by positioning the device in the horizontal orientation or landscape orientation, the system can display both the existing contents on the display and previously placed orders. The content data displayed on the display screen of the mobile device are reoriented such that the content data is correctly displayed right-side-up in the landscape orientation. In such an embodiment, by reorienting the content data in the landscape orientation, the system can display the existing contents and additional content data in a horizontal direction, because there is additional screen real estate for which to present content data to the user. This additional real estate allows the system to better display previously placed orders.

In an embodiment, the mobile application can be configured to display one or more previously placed past orders on the display screen of the mobile device. The user can swipe through and peruse through the previously placed orders in order to make a selection. In an embodiment, the previously placed past orders that are displayed on the mobile device are specific to a particular restaurant, store, or fulfillment entity. Alternatively, the previously placed past order that are displaced on the mobile device are not specific to a particular restaurant, store, or fulfillment entity, but rather the listing of previously placed orders are from a plurality of restaurants, stores, or fulfillment entities.

Optionally, the system can be configured to display previously provided payment information that was utilized in past orders placed by the user. Further, the system can be optionally configured to display previously provided restaurant information from which the user previously placed an order for food. In the landscape orientation, the user can select an icon representing a previously placed order for food and then hit a “purchase” button. By selecting the previously placed order and the “purchase” button, the system can be configured to send an order to a main server system that can process the order. Alternatively, the system can be configured to allow the user to select and/or purchase a previously placed food order by speaking to the mobile device of the user. In an embodiment, the order can comprise the food items ordered and the quantity of each item desired for purchase.

In an embodiment, once in the rotated, horizontal, and/or alternative display state, the system can allow the user to purchase one or more displayed previously placed orders. In one embodiment, the user can purchase previously placed orders by rotating the mobile device or other computing system again, in either the same direction or a different direction than the original direction of rotation. In another embodiment, the user can purchase previously placed orders by shaking, rolling or providing some other physical gesture to the mobile device or other computing system. In another embodiment, the user can purchase previously placed orders by swiping across the screen of the mobile device or other computing system. In another embodiment, additionally or alternatively, the user can swipe back or rotate in the reverse direction (relative to the original rotation direction) to go back to the previous display state. In another embodiment, swiping back or rotating in the reverse direction (in other words, rotating the mobile device or other computing system to the original portrait orientation) can allow the system to go back to the previous display state only if no previously placed orders have been selected. Alternatively, when one or more previously placed orders have been selected, swiping back or rotating the mobile device or other computing system in the reverse direction back to the portrait orientation would allow the user to purchase the previously placed orders.

In an embodiment, in the rotated, horizontal, and/or alternative display state, the system can allow the user to combine menu items for purchase. In one embodiment, the user can select one or more previously placed orders to reorder (e.g., with a check box for each previously placed order) to allow the user to purchase more than one previously placed order. In one embodiment, the user can purchase menu items not previously purchased and/or purchase one or more displayed previously placed orders (e.g. one new menu item and two previously placed orders). In one embodiment, the user can select, combine and purchase menu items from one or more previously placed orders (e.g., by selecting specific menu items from previously placed orders) and/or menu items not previously purchased.

In an embodiment, the system can be configured to send the main server system an item number that corresponds to the food items selected. In an embodiment, the system can be optionally configured to send with the order a restaurant location selection or an identification number corresponding to the selected restaurant location.

In an embodiment, the system can be configured to send with the order payment information stored on the mobile device or a payment identification number corresponding to payment information stored in the main server system.

After the order information has been transmitted by the mobile device over a computer network connection to the main server system, the order is processed by the main server system. The main server system can be configured to store the order information in a user account associated with the user. By storing the order information in the user account, the main server system can be configured to utilize past order information for data mining purposes. For example, the main server system can be configured to mine past order data in order to determine marketing campaigns to be applied to a particular user or group of users. Additionally, the main server system can be configured to mine past order data to determine a particular up-sell product to present to the user.

In an embodiment, the main server system can be configured to analyze the current order being made by the user and compare it with past orders by the user and/or past orders by other similar users, in order to determine a product to up-sell to the user. The main server system can be configured to select an up-sell product to present to the user based on the present order, past order history of the user, and/or the past order history of one or more other users.

In an embodiment, the main server system can be configured to transmit the up-sell product information through a computer network connection to the user's mobile device. The user's mobile device can be configured to display the up-sell product information on the mobile display. The mobile device can be configured to present a purchase button on the mobile device for allowing the user to purchase the up-sell product. If the user selects the purchase for the up-sell product, the mobile device can be configured to transmit the order information to the main server through a computer network connection.

In an embodiment, the main server system can be configured to analyze the order information to determine a restaurant location for fulfilling the user's order. In an embodiment, the order can comprise a restaurant location selected by the user. In this case, the main server system can be configured to transmit the order information to the selected store location through a computer network connection. In situations where the store location information is not provided with the order, the main server system can be configured to determine the best location for sending the order for fulfillment.

For example, in an embodiment, the mobile device can be configured to provide or send the geographic location of the mobile device when the mobile device transmits the order to the main server system. Based on the geographic position of the mobile device, the main server system can determine the nearest restaurant for fulfilling the user's food order. After determining the nearest location for the fulfillment of the food order, the main server system can be configured to transmit the order to the restaurant's location.

In an embodiment, the main server can be configured to send a receipt or confirmation message or confirmation code to the user's mobile device through the computer network connection. The mobile device can be configured to store the receipt, confirmation message, or confirmation number in the mobile device such that the user may present such confirmation to the restaurant location upon picking up the food order.

Optionally, the main server system can be configured to analyze and process the payment information provided with the order. By processing the payment information at the main server system, the restaurant location need not process the payment information and need only process the food order for the user. It can be advantageous to process the payment information at the main server system because the main server system may be able to process the payment information on a more cost-effective basis. Alternatively, the payment information can be processed by the restaurant location.

When the order is received by the restaurant location, a fulfillment system at the restaurant location can be configured to display the order for an employee at the restaurant location to process and fulfill the order. The user of the mobile device can then pick up his food order at the restaurant location. Optionally, the user can display the receipt stored in the user's mobile device to a cashier or a barcode reader in order to obtain the user's food order.

In an embodiment, the mobile application can store all new food orders in the memory of the mobile device. In an embodiment, the system can be configured to automatically add all new food orders to the list of previously placed orders that displayed when the mobile device is rotated into a horizontal orientation. In an embodiment, newly placed and/or previously placed food orders can be saved with custom order names automatically generated and/or user-generated. In an embodiment, the user can rename placed orders. In an embodiment, the system can be configured to add all new food orders to the list of previously placed orders only after a certain criteria is satisfied. For example, the criteria can comprise an order frequency threshold level and/or a period of time. For example, a new food order/item must be ordered at least three times within a one month period before the new food order/item is added to the list of previously placed orders. Another possible criterion can comprise a order/item price threshold level. For example, a new food order/item must be less than $50 in order for the new food order to be added to the list of previously placed orders. Other criteria are possible.

One of ordinary skill in the art will appreciate that the foregoing example can be applied to other circumstances and situations outside of the restaurant or food industries. For example, the foregoing system and any other of the rotation-based ordering systems disclosed herein, can be utilized in any industry where there are customers placing repeat orders for products and/or services. For example, the rotation-based ordering systems disclosed herein can be applied to medication orders, consumer product orders, office supply orders, grocery orders, monthly utility bill orders, and the like.

### Example Rotation Embodiments

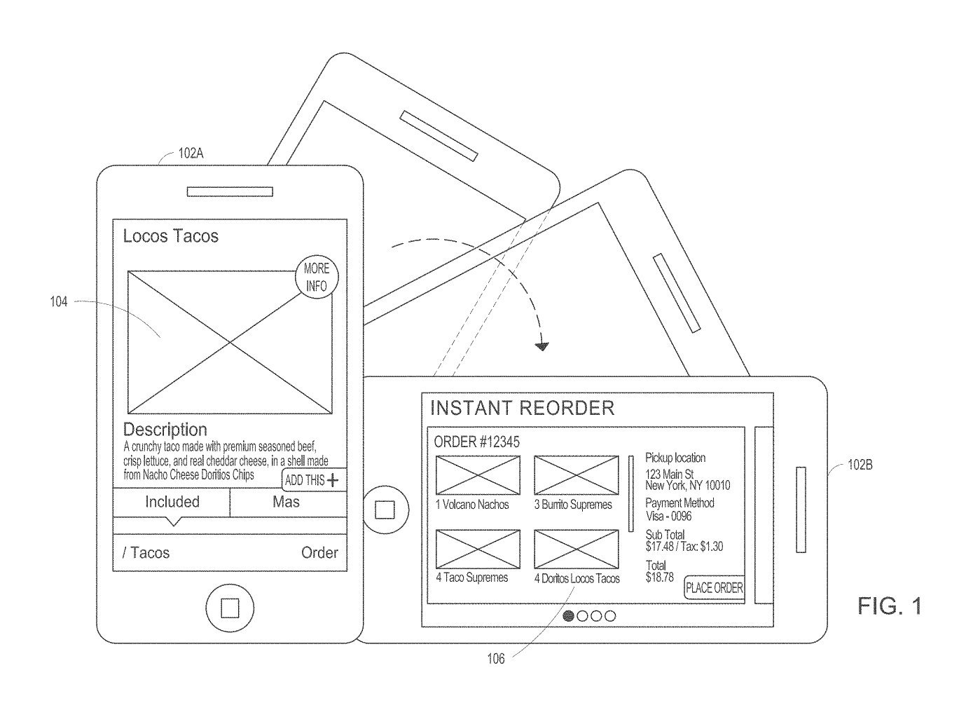

FIG. 1 is an embodiment of a schematic diagram illustrating a mobile device or other computing system 102. In an embodiment, the mobile device or other computing system 102 can be configured to operate a mobile application 104. The mobile application 104 can be a rotation-based ordering system that allows a user to place an order on the mobile device for fulfillment at a store location.

As illustrated in FIG. 1, the mobile device or other computing system 102 can be placed in a vertical position or portrait orientation 102a. The system can be configured to display a “home” page or other menu page when the mobile device or other computing system 102 is placed in a vertical position or portrait orientation 102a. The system can be configured to display on the mobile device or other computing system 102 an instant “order” page or a “previously placed order” menu page 106 when the mobile device or other computing system 102 is positioned in a horizontal position or landscape orientation 102b. By positioning the mobile device or other computing system in a horizontal position or landscape orientation 102b, the system can be configured to present to the user previously placed orders. The previously placed orders can include those that were purchased using a mobile device or other computing system and can include previously placed orders that were purchased using the rotation-based ordering system.

In an embodiment, the system can determine the orientation of the mobile device or other computing system 102 by interfacing with the hardware and software of the device. For example, many mobile devices comprise an operating system that allows application programs to call the operating system in order to determine the orientation of the mobile device. In many mobile phones, the operating system can be configured to interface with a gyroscope and/or accelerometer that are built into the mobile device. Based on detecting data from the accelerometer and/or the gyroscope in the mobile device, the operating system of the mobile device can determine the orientation of the mobile device. The orientation data determined by the operating system can be transmitted or passed to the software application for further processing by the software application.

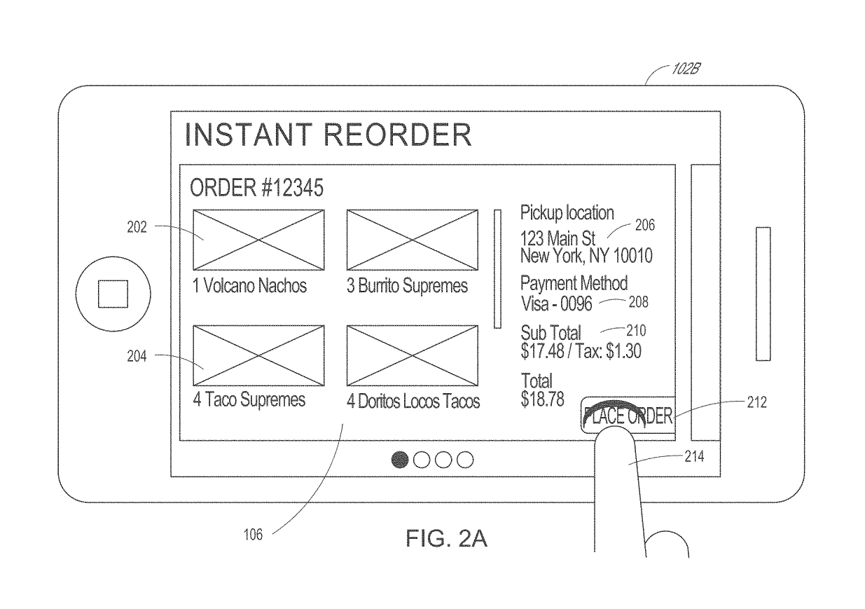

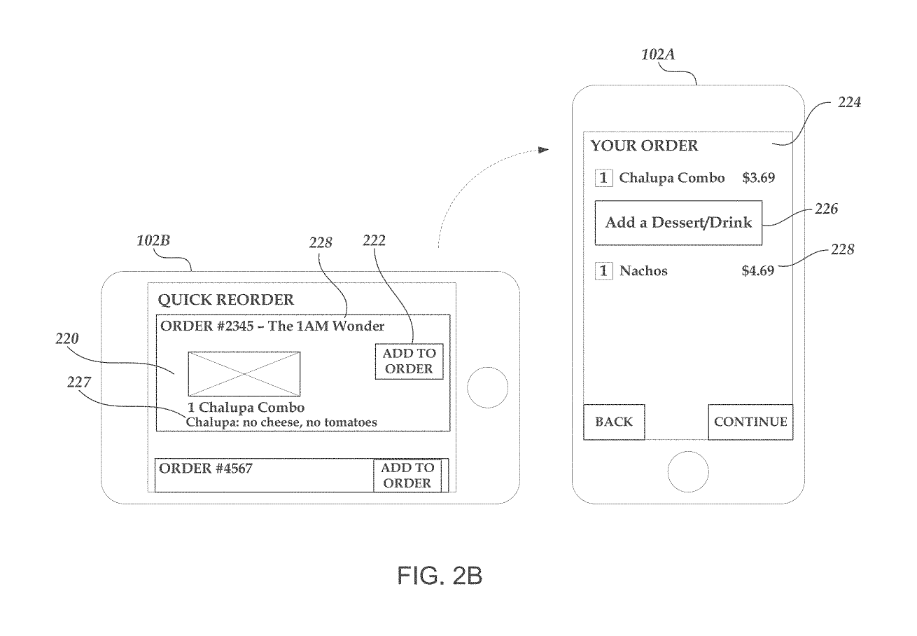

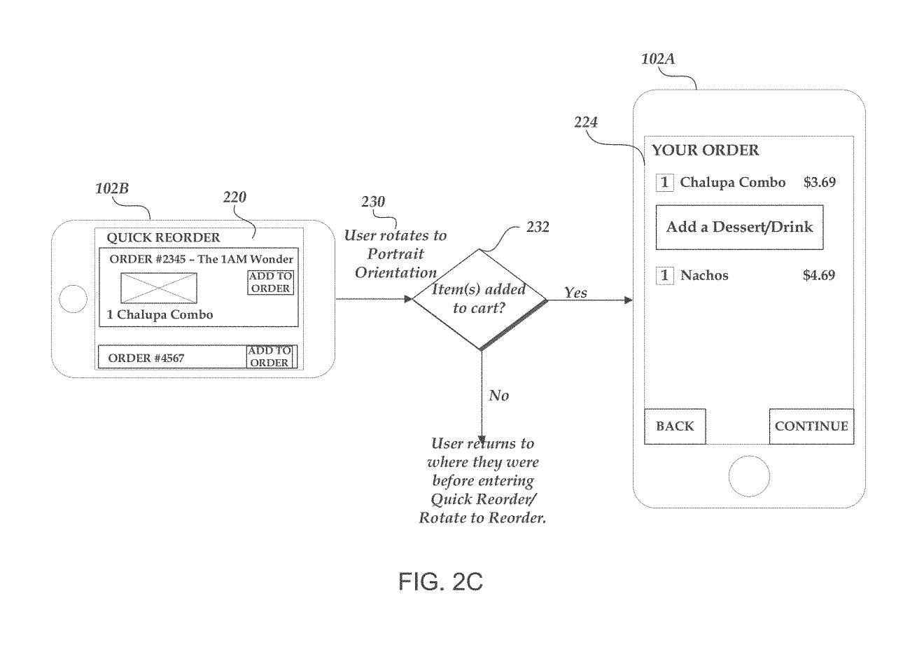

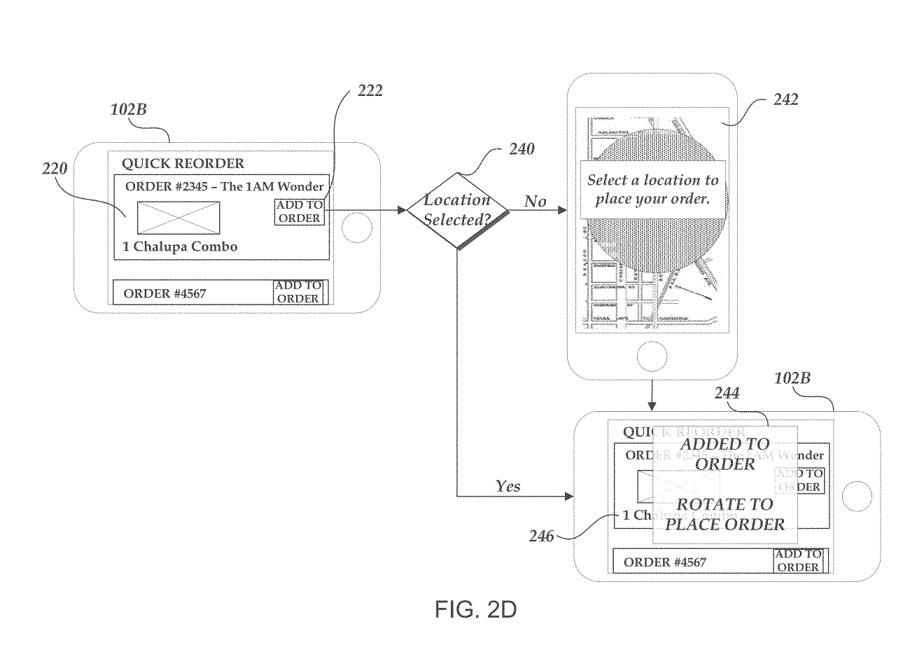

FIGS. 2A, 2B, 2C, and 2D depict an embodiment of a schematic diagram illustrating a mobile device or other computing system 102 in a horizontal position or landscape orientation 102b. In the horizontal position or landscape orientation 102b, the system can be configured to display to the user prior-placed orders 202 using the rotation-based ordering system. In an embodiment, the system can be configured to additionally display prior-placed orders 204 using other systems other than the rotation-based system.

In an embodiment, the system can be configured to optionally display a store or fulfillment entity location 206. The store or fulfillment entity location 206 can be a previously provided store or fulfillment entity location selected by the user in a prior order. In an embodiment, the store or fulfillment entity location can be dynamically generated by the system based on the geographic position, as determined by the mobile device of the user. For example, the system can utilize the GPS location system of the mobile device to determine the geographic location of the user. The system, based on the geographic location, can determine the nearest store or fulfillment entity location for fulfilling the order.

In an embodiment, the system can be configured to display payment information 208. The payment information 208 can be payment information that the user previously provided or used in paying for prior-placed orders. In an embodiment, the system can be configured to interface with an electronic wallet stored on the mobile device in order to dynamically obtain payment information for placing an order. In an embodiment, the system can be configured to display a purchase order total 210. The purchase order total 210 can be dynamically generated based on the selected prior-placed order. In an embodiment, the system can be configured to display an order button 212 which the user's finger 214 can select for placing an order.

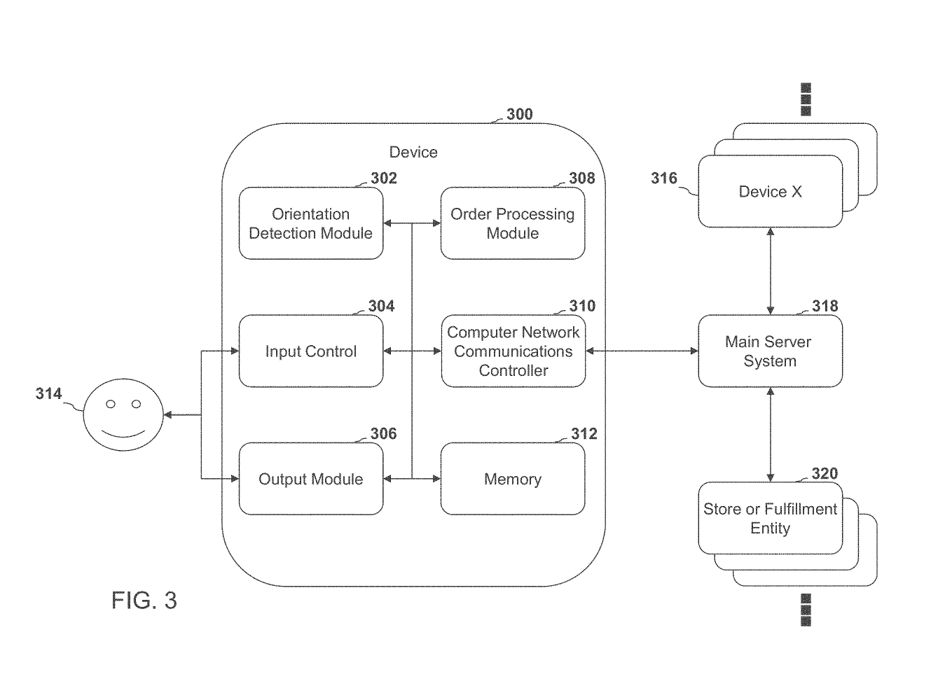

FIG. 3 is a block diagram depicting a high-level overview of an embodiment of a rotation-based ordering system. In an embodiment, the rotation-based ordering system comprises a device 300, which can include, without limitation, a mobile device, tablet computer, laptop computer, smartphone, or other computing device.

In an embodiment, the device 300 can comprise an orientation detection module 302 for detecting the orientation of the device 300. In an embodiment, the device 300 can comprise an order processing module 308 configured to process orders placed by a user 314 of the device 300. In an embodiment, the device 300 can comprise a memory 312 for storing data, such as order processing data, receipt data, store data, and the like.

In an embodiment, the device 300 can comprise an input control 304 and an output module 306 for interfacing with the user 314. The input control 304 can be configured to receive input from the user 314. The output module 306 can be configured to display or present data or content to the user 314. In an embodiment, the device 300 can be configured to comprise a computer network communications controller 310 for interfacing with a main server system 318 over a computer network connection. The computer network connection can include, without limitation, wireless connections, cellular connections, wired connections, or a combination of the foregoing.

In an embodiment, the device 300 can communicate with the main server system 318 over text messaging protocol, HTTP protocol, or any other similar messaging protocol. In an embodiment, the main server system 318 can be configured to communicate with a plurality of other devices 316. The main server system 318 can communicate with device 300 and the plurality of other devices 316 in order to receive order information from various users 314. The main server system 318 can process such orders and send such order information to a store or fulfillment entity 310. In an embodiment, the main server system 318 can communicate with a plurality of stores or fulfillment entities 310. Stores or fulfillment entities 320 can be configured to receive order information from a main server system in order to fulfill the order placed by users 314.

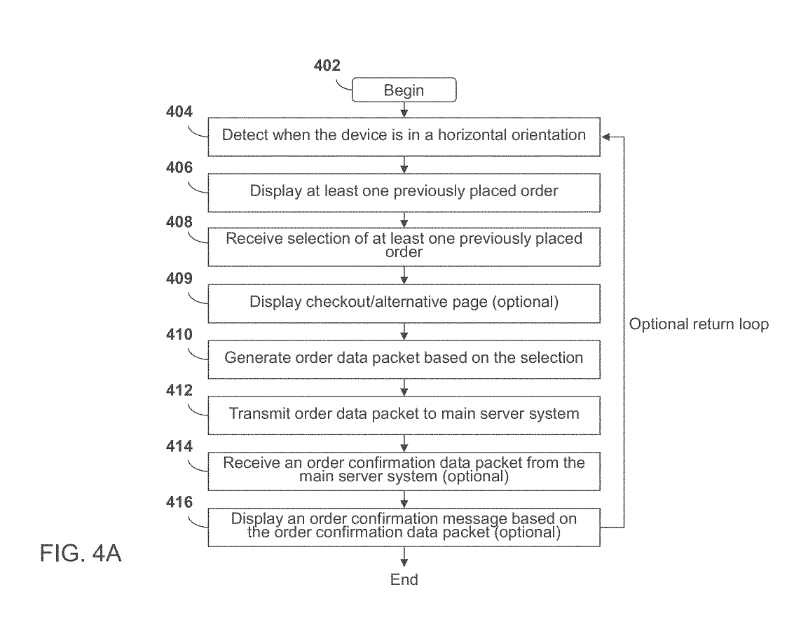

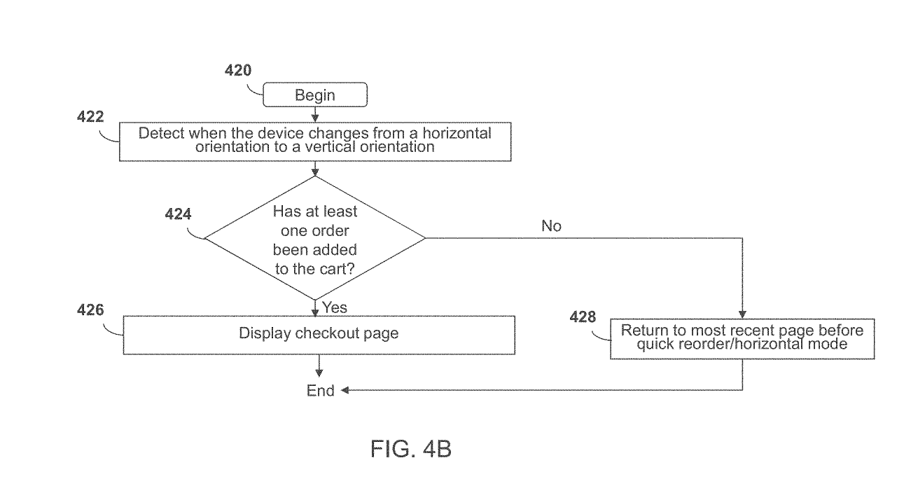

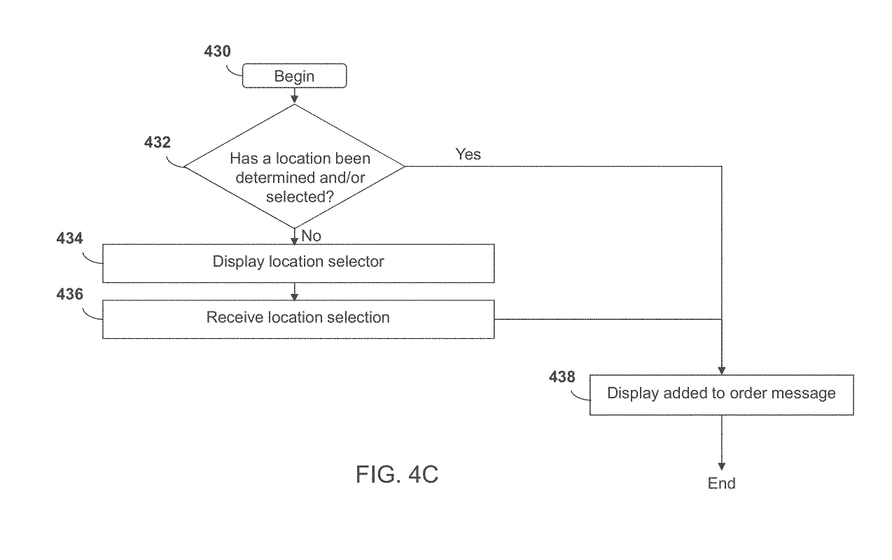

FIGS. 4A, 4B, and 4C depict a flow chart depicting an embodiment of a process for a rotation-based ordering system. In an embodiment, the process can begin at block 402 and proceed to block 404 to detect when the device is in a horizontal orientation. At block 406, the system can be configured to display at least one previously placed order. At block 408, the system can be configured to receive selection information or data of at least one previously placed order from the user. At block 410, the system can be configured to generate an order data packet based on the selection placed by the user. At block 412, the system can be configured to transmit the order data packet to a main server system through a computer network connection.

At block 414, the system can be configured to optionally receive an order confirmation data packet from the main server system through a computer network connection. At block 416, the system can be configured to optionally display an order confirmation message based on the order confirmation data packet that was received from the main server system. In an embodiment, the system can be configured to optionally return to block 404 to detect the next time period when the device is positioned in a horizontal orientation.

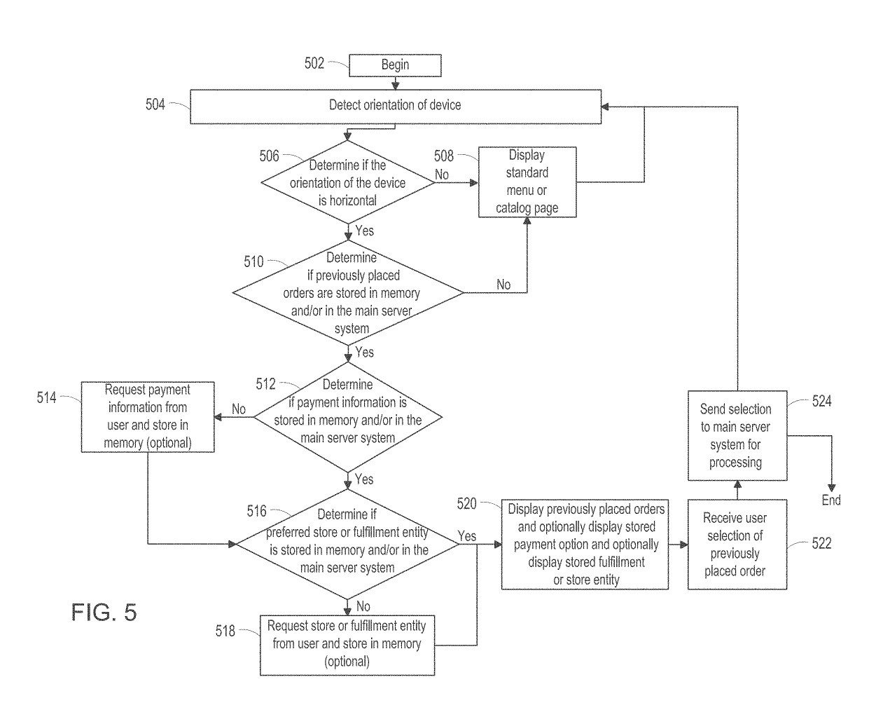

FIG. 5 is a flow chart depicting an embodiment of a process for a rotation-based ordering system. The process can begin at block 502 and proceed to block 504 to detect the orientation of the device. At decision block 506, the system can be configured to determine if the orientation of the device is in a horizontal orientation. If the system determines that the mobile device is not in a horizontal position, then the system, at block 508, can be configured to display the standard menu or catalog page. The system can then be configured to return back to block 504 to determine the next orientation of the device.

Returning to decision block 506, if the system detects that the orientation of the device is horizontal, then the system, at decision block 510, can be configured to determine if previously placed orders are stored in memory of the device and/or are stored in the main server system. If no previously placed orders are stored in the memory of the device and/or are stored in the main server system, the system can be configured to display standard menu or catalog page information at block 508 and return back to block 504.

If the system, at decision block 510, determines that there is stored previously placed order data, then the system, at decision block 512, can be configured to determine if payment information is stored in the memory of the device and/or in the main server system. If the system determines that there is no payment information stored, then the system, at block 514, the system can be configured to optionally request payment information from the user and store it in the memory of the device. The request for payment information can be made directly to the user through the mobile device or, alternatively, the request for payment information can be made by the mobile device to an electronic wallet stored in the mobile device.

If the system determines, at block 512, that payment information is stored in memory or that the system has received payment information, then the system, at decision block 516, can be configured to determine if a preferred store or fulfillment entity location is stored in memory and/or is stored in the main server system. If there is no known store or fulfillment entity location information, then at block 518, the system can be configured to optionally request store or fulfillment entity information from the user and store it in memory.

At block 520, the system can be configured to display previously placed orders and optionally display stored payment information and optionally stored fulfillment or store entity information. At block 522, the system can be configured to receive a user's selection of a previously placed order. At block 524, the system can be configured to send the selection to the main server system for processing. The system can be configured to optionally return to block 504 to detect the orientation of the device.

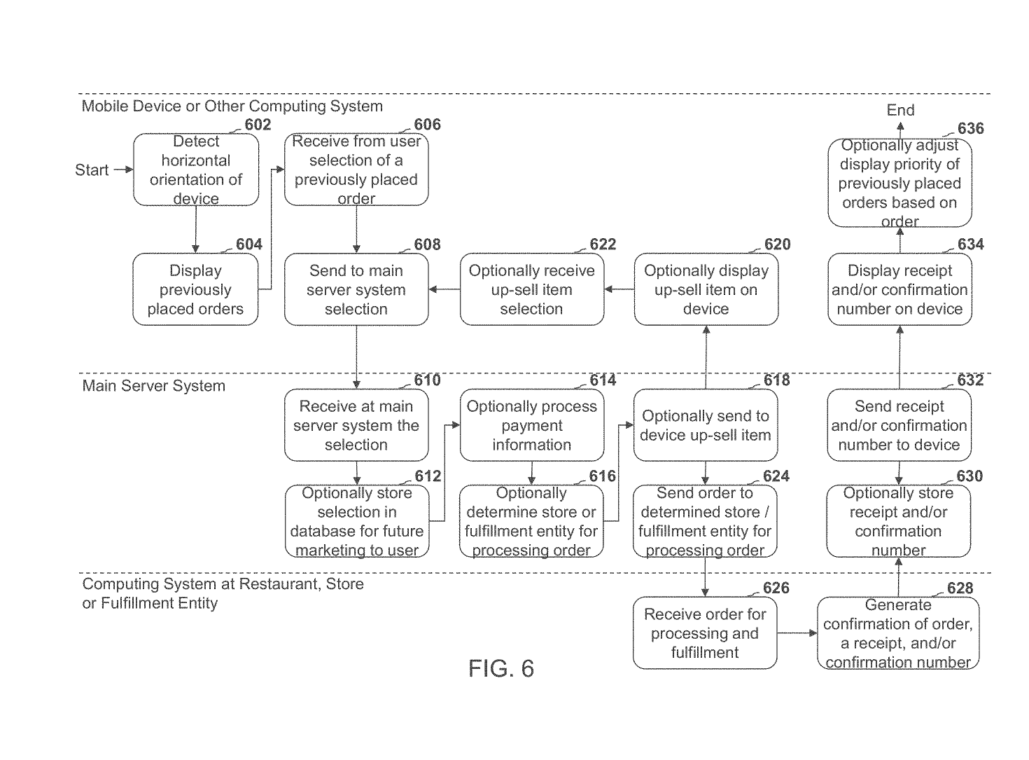

FIG. 6 is a flow chart depicting an embodiment of a process for a rotation-based ordering system. The process can start at block 602 by detecting the horizontal orientation of the device. At block 604, the system can be configured to display previously placed order on the device. At block 606, the system can be configured to receive from the user of the device a selection of a previously placed order. At block 608, the system can be configured to send from the device to the main server system, the selection received by the user. At block 610, the main server system can be configured to receive from the device for selection from the user.

At block 612, the system can optionally store the selection that was submitted by the user in a database for future marking to the user. At block 614, the system can optionally process the payment information received from the device with the order. At block 616, the system can be configured to optionally determine a store or fulfillment entity for processing the order. At block 618, the system can be configured to optionally send an up-sell item to the device for presentation to the user. At block 620, the device can be configured to optionally display the up-sell item on the device for the user to review.

At block 622, the system can be configured to optionally receive and up-sell a selection from the user. At block 608, the system can be configured to send to the main server system the selection of the up-sell item. At block 624, the system can be configured to send the order to the determined store or fulfillment entity for processing of the order. At block 626, the order is received by the store or fulfillment entity for processing and fulfillment. At block 628, the system can be configured to generate a confirmation of the order, a receipt, and/or a confirmation number for transmitting to the main server system and/or the mobile device.

At block 630, the system can be configured to optionally at least store the receipt and/or the confirmation number at the main server system. At block 632, the system can be configured to send the receipt and/or the confirmation number to the device. At block 634, the system can be configured to display and/or store receipt and or confirmation number on the device, for the user's review.

At block 636, the system can be configured to optionally adjust the display priority of previously placed orders based on the current order. For example, the system can be configured to display previously placed orders on a priority-ranking basis. In an embodiment, the priority-ranking basis can be based on the number of times a user has previously placed the same prior-placed order. For example, prior-placed orders with the highest number of orders appear at the top of the priority list.

In an embodiment, the system can be configured to dynamically adjust the prioritization of the prior-placed orders, based on the current order. Specifically, the system can be configured to add another order to the prior-placed order and to determine whether the additional order to the prior-placed order is sufficient to readjust the prioritization of the listing of prior-placed orders. In an embodiment, the system can end the process at block 636.

### Example Computing System

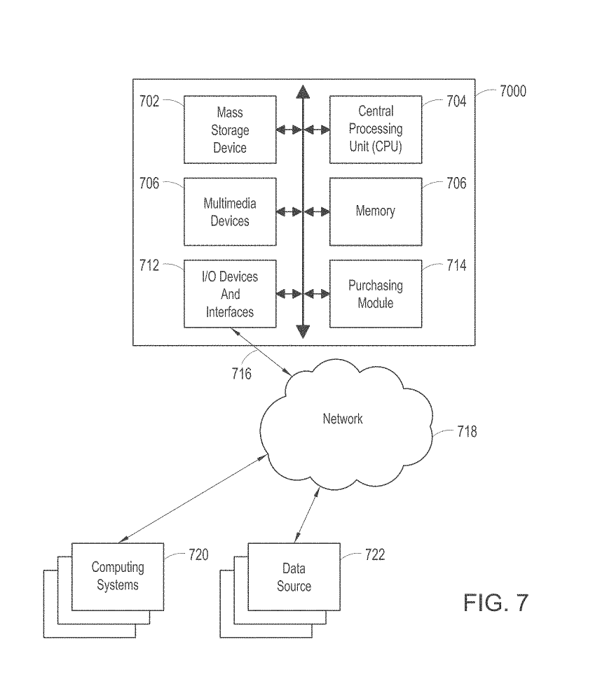

In some embodiments, the computer clients and/or servers described above take the form of a computing system 700 illustrated in FIG. 7, which is a block diagram of one embodiment of a computing system that is in communication with one or more computing systems 720 and/or one or more data sources 722 via one or more networks 718. The computing system 700 may be used to implement one or more of the systems and methods described herein. In addition, in one embodiment, the computing system 700 may be configured to apply one or more of the rotation-based ordering methods and systems described herein. While FIG. 7 illustrates an embodiment of a computing system 700, it is recognized that the functionality provided for in the components and modules of computing system 700 may be combined into fewer components and modules or further separated into additional components and modules.

### Example Rotation-Based Ordering Control System

In an embodiment, the system 700 comprises a rotation-based ordering system module 714 that carries out the functions described herein with reference to rotation-based ordering mechanisms, including any one of the rotation-based ordering methods described above. The rotation-based ordering system module 714 may be executed on the computing system 700 by a central processing unit 704 discussed further below.

In general, the word “module,” as used herein, refers to logic embodied in hardware or firmware, or to a collection of software instructions, possibly having entry and exit points, written in a programming language, such as, for example, COBOL, CICS, Java, Lua, C or C++ or Objective C. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

### Example Computing System Components

In an embodiment, the computing system 700 also comprises an iPhone®, iPad®, or other computing devices suitable for controlling and/or communicating with large databases, performing transaction processing, and generating reports from large databases. The computing system 700 also comprises a central processing unit (“CPU”) 704, which may comprise a conventional microprocessor. The computing system 700 further comprises a memory 708, such as random access memory (“RAM”) for temporary storage of information and/or a read only memory (“ROM”) for permanent storage of information, and a mass storage device 702, such as a hard drive, diskette, or optical media storage device. Typically, the modules of the computing system 700 are connected to the computer using a standards based bus system. In different embodiments, the standards based bus system could be Peripheral Component Interconnect (PCI), Microchannel, SCSI, Industrial Standard Architecture (ISA) and Extended ISA (EISA) architectures, for example.

The computing system 700 comprises one or more commonly available input/output (I/O) devices and interfaces 712, such as a keyboard, mouse, touchpad, and printer. In one embodiment, the I/O devices and interfaces 712 comprise one or more display devices, such as a monitor, that allows the visual presentation of data to a user. More particularly, a display device provides for the presentation of GUIs, application software data, and multimedia presentations, for example. In the embodiment of FIG. 7, the I/O devices and interfaces 712 also provide a communications interface to various external devices. The computing system 700 may also comprise one or more multimedia devices 706, such as speakers, video cards, graphics accelerators, and microphones, for example.

### Example Computing System Device/Operating System

The computing system 700 may run on a variety of computing devices, such as, for example, a mobile device or a server, a Windows server, an Structure Query Language server, a Unix server, a personal computer, a mainframe computer, a laptop computer, a cell phone, a personal digital assistant, a kiosk, an audio player, a smartphone, a tablet computing device, and so forth. The computing system 700 is generally controlled and coordinated by operating system software, such as iOS, z/OS, Windows 95, Windows 98, Windows NT, Windows 2000, Windows XP, Windows Vista, Windows 7, Linux, BSD, SunOS, Solaris, or other compatible operating systems. In Macintosh systems, the operating system may be any available operating system, such as MAC OS X. In other embodiments, the computing system 700 may be controlled by a proprietary operating system. Conventional operating systems control and schedule computer processes for execution, perform memory management, provide file system, networking, and I/O services, and provide a user interface, such as a graphical user interface (“GUI”), among other things.

### Example Network

In the embodiment of FIG. 7, the computing system 700 is coupled to a network 718, such as a LAN, WAN, or the Internet, for example, via a wired, wireless, or combination of wired and wireless, communication link 716. The network 718 communicates with various computing devices and/or other electronic devices via wired or wireless communication links. In the embodiment of FIG. 7, the network 718 is communicating with one or more computing systems 720 and/or one or more data sources 722.

Access to the rotation-based ordering system module 714 of the computer system 700 by computing systems 720 and/or by data sources 722 may be through a web-enabled user access point such as the computing systems' 720 or data source's 722 personal computer, cellular phone, laptop, or other device capable of connecting to the network 718. Such a device may have a browser module is implemented as a module that uses text, graphics, audio, video, and other media to present data and to allow interaction with data via the network 718.

The browser module may be implemented as a combination of an all points addressable display such as a cathode-ray tube (CRT), a liquid crystal display (LCD), a plasma display, touch screen display or other types and/or combinations of displays. In addition, the browser module may be implemented to communicate with input devices 712 and may also comprise software with the appropriate interfaces which allow a user to access data through the use of stylized screen elements such as, for example, menus, windows, dialog boxes, toolbars, and controls (for example, radio buttons, check boxes, sliding scales, and so forth). Furthermore, the browser module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition a touch screen may act as a hybrid input/output device. In another embodiment, a user may interact with the system more directly such as through a system terminal connected to the score generator without communications over the Internet, a WAN, or LAN, or similar network.

In some embodiments, the system 700 may comprise a physical or logical connection established between a remote microprocessor and a mainframe host computer for the express purpose of uploading, downloading, or viewing interactive data and databases on-line in real time. The remote microprocessor may be operated by an entity operating the computer system 700, including the client server systems or the main server system, an/or may be operated by one or more of the data sources 722 and/or one or more of the computing systems. In some embodiments, terminal emulation software may be used on the microprocessor for participating in the micro-mainframe link.

In some embodiments, computing systems 720 that are internal to an entity operating the computer system 700 may access the rotation-based ordering system module 714 internally as an application or process run by the CPU 704.

### Example User Access Point

In an embodiment, the computing system 700 comprises an iPhone®, an iPad®, Android computing system, a smartphone, a tablet computing device, a mobile device, a personal computer, a laptop computer, a cellular phone, a GPS system, a Blackberry® device, a portable computing device, a server, a computer workstation, a local area network of individual computers, an interactive kiosk, a personal digital assistant, an interactive wireless communications device, a handheld computer, an embedded computing device, or the like.

### Example Other Systems

In addition to the systems that are illustrated in FIG. 7, the network 718 may communicate with other data sources or other computing devices. The computing system 700 may also comprise one or more internal and/or external data sources. In some embodiments, one or more of the data repositories and the data sources may be implemented using a relational database, such as DB2, Sybase, Oracle, CodeBase and Microsoft® SQL Server as well as other types of databases such as, for example, a signal database, object-oriented database, and/or a record-based database.

### Example Swipe and Other Rapid Reorder Embodiments

Rapid reordering may be accomplished in ways other than by rotating a device. Instead, for instance, rapid reordering may be performed by a two-step process involving other input functions. A user interface may present a user with a first user interface control, which can be a button or other user interface control that enables a user interface to initiate an express reorder of a previously-ordered item. Once the user has selected the button, the user interface can present default details about the order along with a second user interface control, which can be a swipe bar or another button (or some other control). User selection of the second user interface control can complete the reorder process. Although described with respect to reordering, this two-step process can also be used for ordering items not previously ordered by a user before. For convenience, however, the remainder of this disclosure discusses reordering as an example implementation.

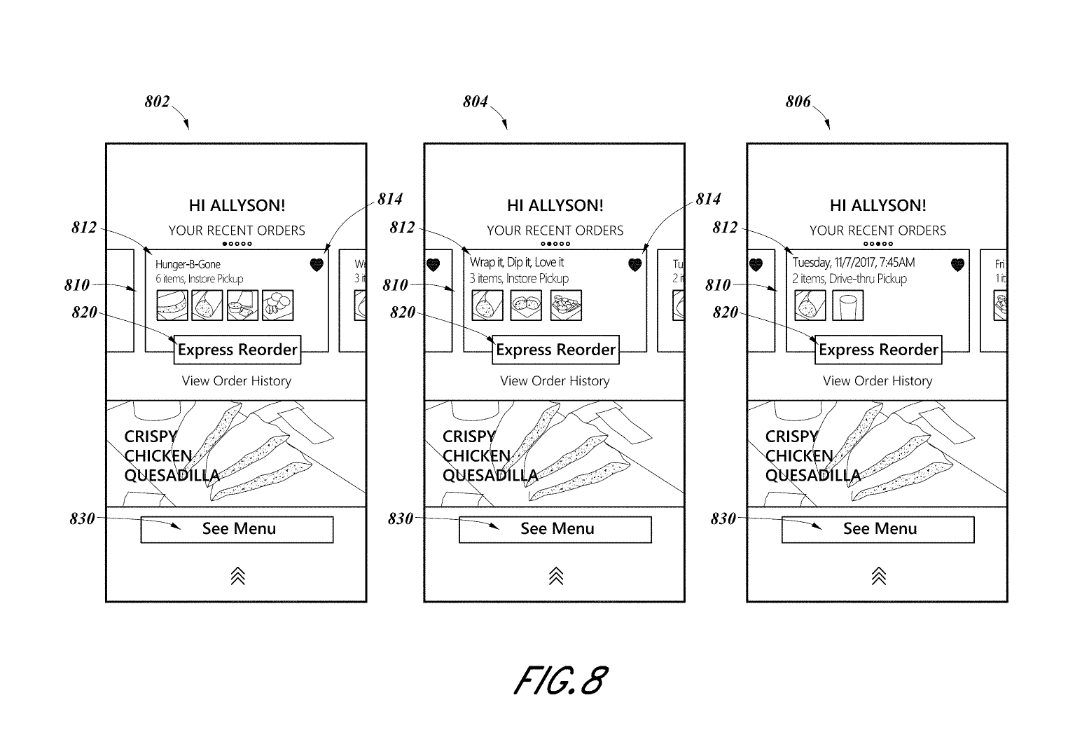

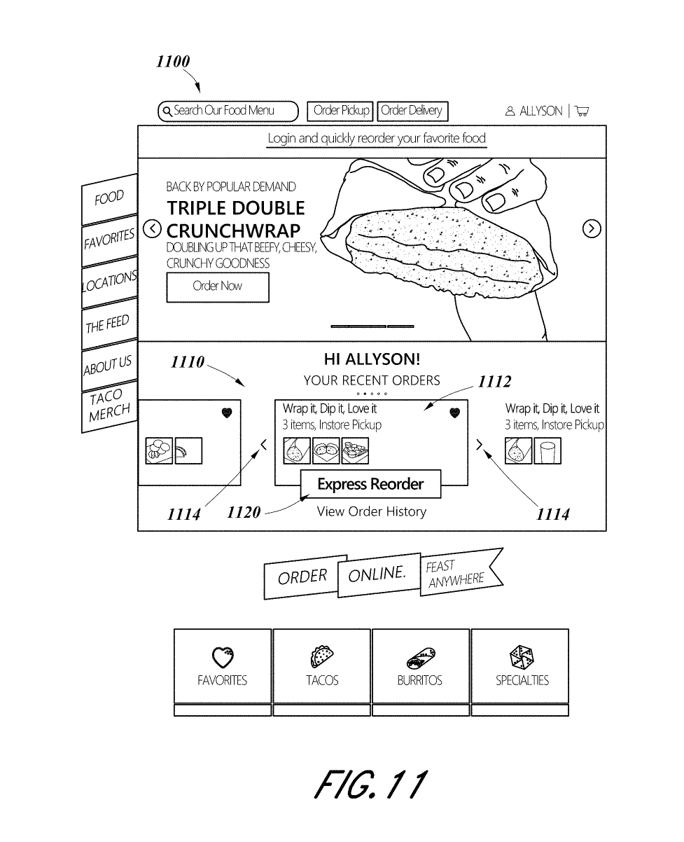

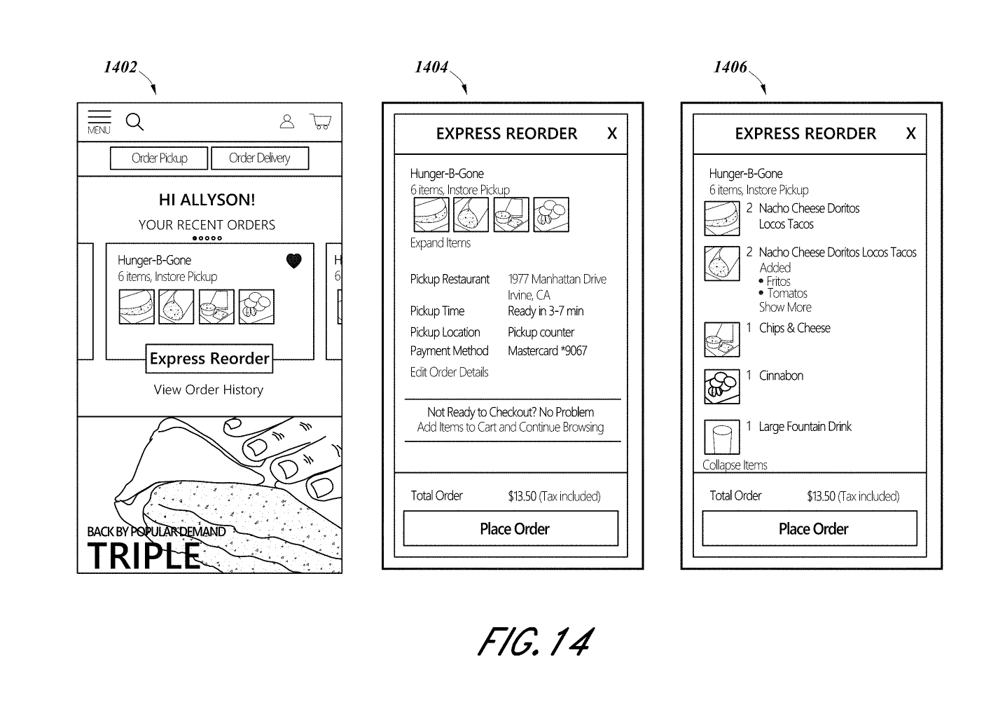

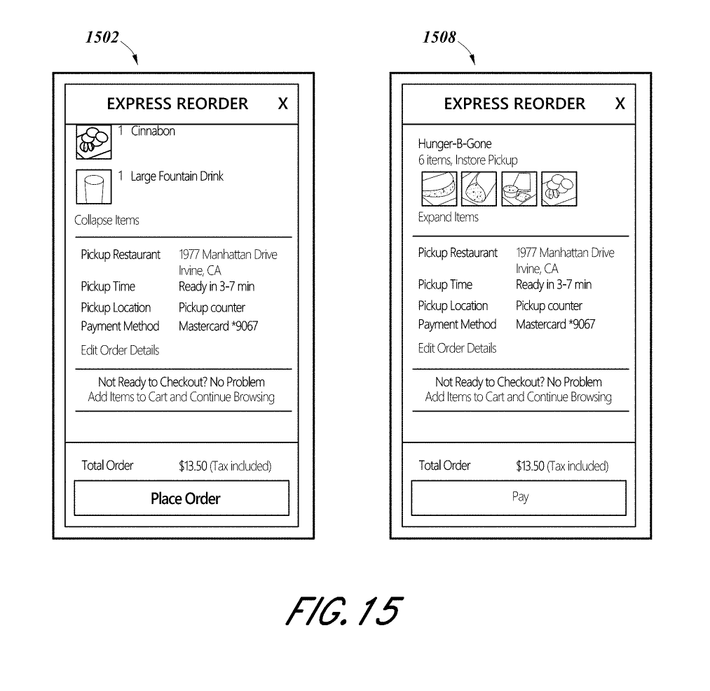

FIGS. 8-15 depict various example user interfaces for reordering items, such as items at a restaurant (although these features are not limited to restaurant items or even food items, but encompass any product, whether physical or digital). These user interfaces can be implemented by any of the user devices described above and may be output by any of the systems described above. For instance, the user interfaces in FIGS. 8-10 are example user interfaces that can be output by a mobile application operating in the user device, such as a smart phone, tablet or the like. FIGS. 11-13 depict example user interfaces that can be output on a desktop computer, a laptop computer, or the like. FIGS. 14 and 15 depict user interfaces that can be also output on a mobile device, but in web page format instead of the mobile application format shown in FIGS. 8-10.

In various implementations described herein, the user interfaces shown can be used by a user to quickly reorder one or more items that the user had previously purchased, such as a restaurant order. The rapid reordering technique shown and described with respect to these figures can include a two-step reordering technique, where a first step includes selecting a previous order and a second step includes confirming that order using one of a variety of potential input options. For example, these input options can include pressing a button or swiping across a display. In the mobile application context, either of these input options can be used, among others. However, in the web application context, typically a button press is used as swiping is not often used in the browser, although it may be in some embodiments.

Swiping to confirm an order can be advantageous because mobile users that have to swipe to confirm a reorder may be less likely to mistakenly place the reorder, whereas if a button is used instead, then a user may accidently press the button more easily than accidently swiping across a screen. Thus, with swiping, fewer orders may need to be canceled due to mistaken reordering.

Turning to the mobile application screens in FIGS. 8-10 and specifically referring to FIG. 8, three example recent order user interfaces 802, 804, and 806 are shown. The recent order user interfaces 802-806 present images and text describing orders that a user has recently ordered and provide options for users to either rapidly reorder one of those previous orders or to view a menu and perform a normal order.

Referring specifically to the left-most recent order user interface 802, a carousel 810 of previous orders 812 is depicted in the user interface 802. The carousel 810 may be swiped from left to right or from right to left to see additional previous orders 812. Some previous orders 812 are favorite orders marked as favorites by a heart symbol 814, as shown in the user interfaces 802 and 804, while other previous orders 812 are merely non-favorite recent orders as shown in the user interface 806 (the recent order 812 is titled “Tuesday, Nov. 7, 2017, 7:45 AM”).

The previous orders 812 in the user interfaces 802 and 804 are both marked as favorites by the favorite icon 814, and as such each have been titled with a custom title provided by the user. Options for creating favorite orders and customizing titles for favorite orders are described in U.S. Provisional Application No. 62/620,242 filed Jan. 22, 2018, titled “Methods and Architectures for an Online Ordering System,” the disclosure of which is hereby incorporated by reference in its entirety. For instance, the previous order 812 in the recent order user interface 802 has the custom title “Hunger-B-Gone,” whereas the previous order 812 in the user interface 804 has the custom title “Wrap It, Dip It, Love It.” Custom titles may be created by users, but the mobile application can optionally prevent inappropriate or offensive language from being associated with an order, for example, by parsing the custom title and determining whether any portion of the title matches a list of offensive terms. Custom titles are optional, and users need not add them.

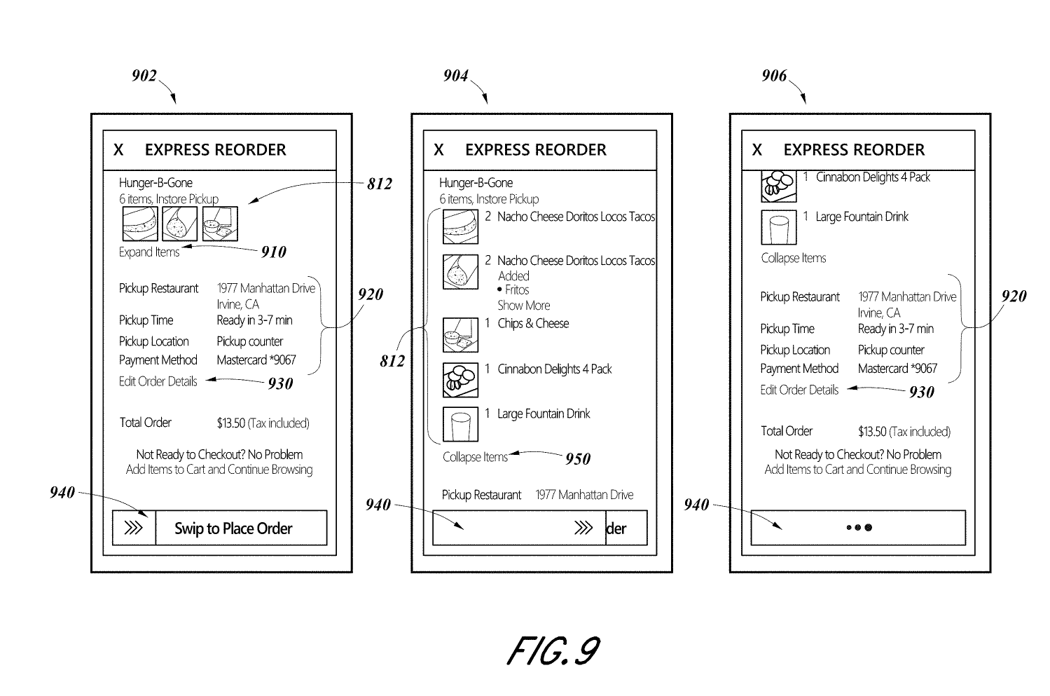

Once a user has caused the carousel 810 to display the order 812 that the user would like to reorder, the user can press the express reorder button 820 to initiate an express reorder described below with respect to FIG. 9. Although the express reorder button 820 is shown as a button, it may also be a swipe control (or swipe bar) or some other user interface control. Alternatively, the user can select the menu button 830 if she does not want to reorder but would prefer to instead start a new order.

The carousel 810 can be populated with any number of previous orders, including some or all of the user's favorite orders as well as any number of recent orders. For example, the carousel 810 may include ten orders, some of which are favorites and others of which are recent orders, and which may be non-duplicative recent orders. Any other number of favorites or recent orders may be included in the carousel 810. Although a carousel 810 is shown for navigating previous orders, other options for reviewing previous orders may be provided, such as a drop down box or a list of icons depicting each order, or the like.

Selection of the express reorder button 820 can cause a user interface to be displayed for reordering, such as any of the express reorder user interfaces 902, 904, or 906 shown in FIG. 9. Referring specifically to the user interface 902, at the top of the user interface is depicted the previous order 812, the same previous order from the recent order user interface that was selected in the carousel 810 when the express reorder button 820 was selected. As shown, the selected previous order 812 includes six items in this example, but any number of items may be included in an order.

Beneath the previous order 812 is an expand link 910 for expanding the items in the order. Selection of this expand link 910 can cause the previous order 812 to be expanded so that each of the items in the order is visible along with corresponding text describing those items. The user interface 904 depicts a user interface where the expand items 910 link has been selected. The previous order 812 in the user interface 904 is expanded as a vertical list with a picture corresponding to each item. Next to each picture is a number of those items to be reordered, as well as a textual description of that item, such as “Bean Burrito.”

Referring again to the user interface 902, beneath the expand link 910 are default order details 920. These default order details 920 in this example include the pickup restaurant, pickup time, pickup location and payment method, each of which may be previously set by the user either in a preferences section of the application or simply by the user's previous order. The pickup restaurant may differ from the pickup location in that the pickup restaurant can be provided as an address, whereas the location can refer to a portion or area in the restaurant, such as a pickup counter, a drive-through window, or the like. The default order details 920 may be edited by selecting the edit order details link 930. If the user selects that link 930, then the mobile application can exit from express reordering mode and enter into a normal checkout mode.

The pickup restaurant shown in the default order details 920 may be selected in any number of ways. Logic for selecting the pickup restaurant can include identifying the previous restaurant the user ordered at, identifying the closest restaurant to the user, or some combination of the same. In an example, the pickup restaurant is selected to be the restaurant the user typically orders at or most recently ordered at if the user is within 15 miles of that restaurant. The distance from the restaurant to the user's mobile device may be determined by the mobile application accessing GPS data available from a GPS service installed in an operating system or separate application of the mobile device. From that service or application, the mobile application can determine the current location of the mobile device and ascertain the distance to the pickup restaurant. In one example implementation, the GPS application sends the previous pickup location or the user's usual pickup location along with the current location of the mobile device to a remote service, such as the main server system described above. The remote service can determine the calculation of distance between the restaurant and the mobile device very quickly and can return that data to the mobile application over the network.

If the user is outside the 15 mile distance or radius from the typical or most recently visited restaurant, then the mobile application (optionally in conjunction with the server) can select the restaurant in a chain of restaurants that is nearest to the user's mobile device. Although 15 miles is used in the previous example, any distance may be used to perform similar default restaurant selection logic, such as five miles, 10 miles, 20 miles, or some other distance.

If the user does not edit the order details by selecting the link 930 and is ready to check out, the user can select a swipe control 940 by swiping with the user's finger across the screen from left to right (or optionally from right to left). The user interface 902 shows the swipe control 940 having been not yet actuated by the user. The user interface 904 shows the swipe control 940 having been partially swiped by the user, with a corresponding change in the animation or depiction of the swipe control. In particular, three chevrons present at the left of the swipe control in the user interface 902 have moved approximately three-quarters of the way across the swipe control 940 in the user interface 904. This movement can indicate that the chevrons have moved as an animation from left to right across the swipe control 940. The chevrons shown are example graphics that may, but need not, be included on a swipe control. In the user interface 906, the swipe control 940 is shown having completed the swipe and with three dots, which may be animated to show that the mobile application is placing the order.

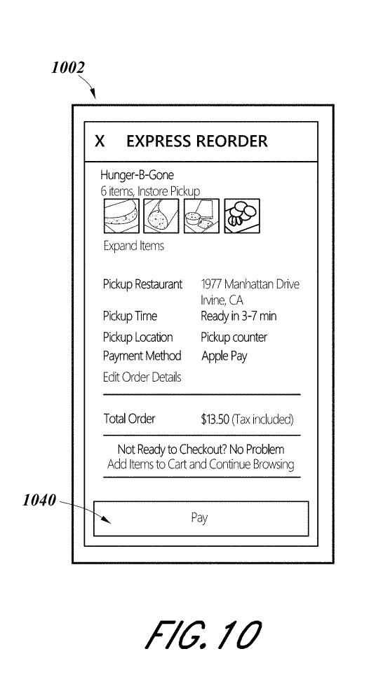

FIG. 10 depicts another example user interface 1002, which is similar to the previous user interfaces in FIG. 9 except that instead of having the swipe control 940 at the bottom, an Apple Pay™ button 1040 is depicted instead. Thus, users that have Apple Pay™ enabled on their user devices can select the Apple Pay™ button 1040 instead of the swipe control 940 to start an order. Other payment wallets may be used instead of or in addition to Apple Pay™, such as Google Pay™.

FIGS. 11-13 depict the example web ordering user interfaces that can be used on a desktop or a laptop computer or the like. These interfaces can include the same or similar functionality as the mobile application user interfaces described above. For example, these interfaces can include two-step express reorder functionality, except that instead of using a swipe button to perform the reordering (which is not commonly done on desktops or laptops), the second step in the reordering can include pressing a button. Of course, swipe controls or other user interface controls may be used instead of a button press in other implementations.

Referring specifically to FIG. 11, an example web ordering user interface 1100 is shown. Similar to the mobile order user interfaces described above, the web ordering user interface 1100 in FIG. 11 includes a carousel 1110 of previous orders 1112. Carousel movement controls 1140, depicted as arrows, can be selected to move the carousel 1110 left or right to select a previous order 1112. Once the previous order 1112 that the user desires is selected, then the user can press an express reorder button 1120, which will initiate the express reorder as the first step in the express reordering process.

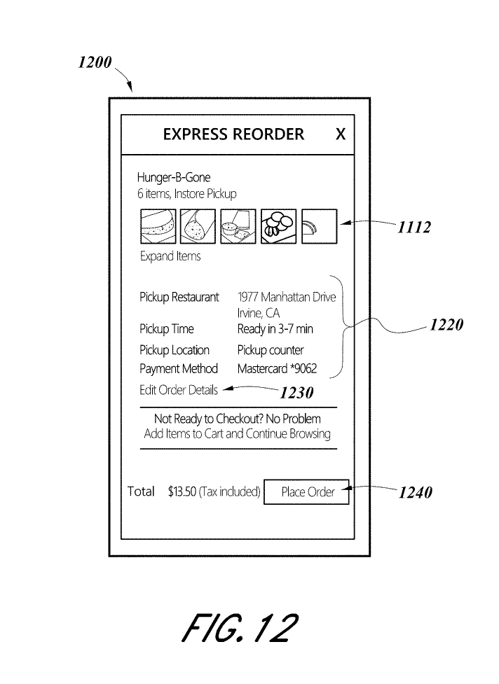

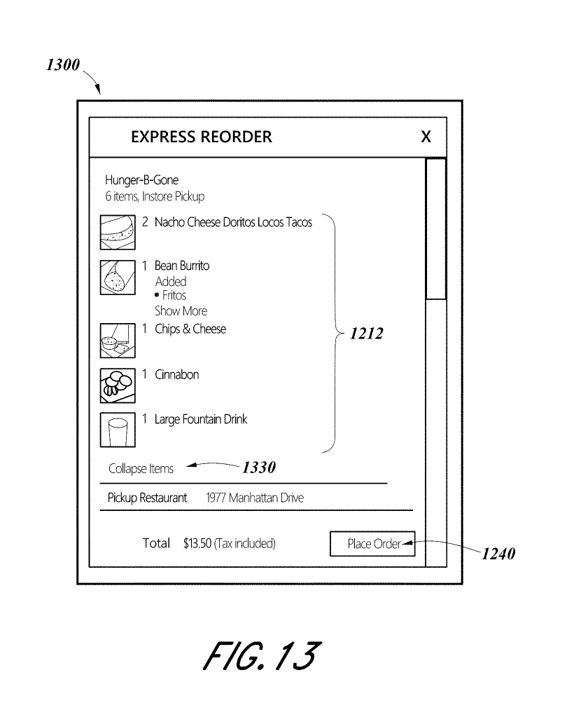

Selection of the express reorder button 1120 can cause a web express reorder user interface 1200 to be displayed, as shown in FIG. 12. This example user interface 1200 depicts a previous order 1112, default order details 1220, and an edit order details link 1230, as well as a place order button 1240 in place of a swipe control. These features can have the same or similar functionality as the corresponding mobile features described above. For example, user selection of an expand items button 1114 can cause a user interface 1300 as shown in FIG. 13 to be displayed. This interface 1300 can be essentially the same user interface as the user interface 1200, but the order 1212 is shown expanded into a vertical list as in FIG. 8. This list can then be collapsed by selecting the collapse items link 1530.

Turning to FIGS. 14 and 15, example mobile web user interfaces are shown, which can have the same or similar functionality as the web ordering interfaces described above with respect to FIGS. 11-13. In FIG. 14, a user interface 1402 shown can have the same or similar functionality as the web interface in FIG. 11. A user interface 1404 shown can also have the same or similar functionality as the interface shown in FIG. 12. Likewise, a user interface 1406 shown can also have the same or similar functionality as the interface shown in FIG. 13. In FIG. 15, the user interface 1502 can also have similar functionality as the user interface 1406 in FIG. 14. Finally, the user interface 1508 can have similar functionality as the user interface 1002 in FIG. 10.

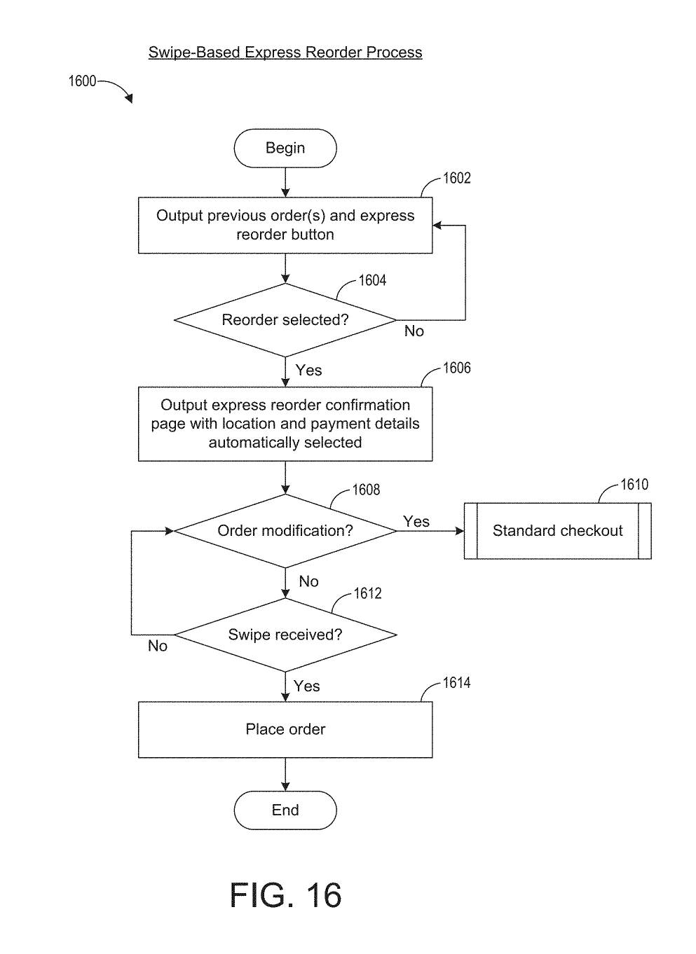

Turning to FIG. 16, an example swipe-based express reorder process 1600 is shown. The process 1600 can be implemented by any of the user devices or systems described above and may implement any of the features described above with respect to the user interfaces shown in FIGS. 8-15.

At block 1602, a mobile device outputs one or more previous orders (and/or favorite orders) and an express reorder button (which need not say “express reorder” but which may embody the same functionality with a different name or image). For example, as described above with respect to FIGS. 8 and 11, the mobile device can determine at block 1604 whether a reorder has been selected. If not, the mobile device can loop back to block 1602 and continue to wait for a user to select the express reorder button. Otherwise, the mobile device can proceed to block 1606, where the mobile device can output an express reorder confirmation page with location and payment details automatically selected as described above.

At block 1608, the mobile device determines whether the user has input an order modification. If so, the mobile device can proceed to a standard checkout at block 1610. If not, the mobile device can determine whether a swipe input (or a button or similar input) has been received from the user at block 1612. If not, the process 1600 loops back to block 1608; otherwise, the process 1600 proceeds to block 1614, where the mobile device places the order.

### Additional Example Features

Any of the preceding express reorder features may be combined with any of the features described in U.S. Provisional Application No. 62/620,242 filed Jan. 22, 2018, titled “Methods and Architectures for an Online Ordering System” (“the '242 application”), the disclosure of which was incorporated by reference above. For instance, the fast favorite feature described in the '242 application may be combined with the swipe-based ordering feature described above. The express reorder may be initiated by performing a 3D touch on the display of the mobile device and completed with a swipe. Further, an order check-in feature may be used, where the express reorder can automatically be sent to the pending order queue in the restaurant. Moreover, the mobile application and/or backend system (for example, the main server system described above) can automatically validate an order based on an updated store location. Some items, for instance, may have a different price or may not be available at certain store locations, so the system can automatically determine the price and item availability after the user selects the express reorder button and before the swipe or place order button is selected.

### Terminology

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a hardware processor comprising digital logic circuitry, a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. A computing environment can include any type of computer system, including, but not limited to, a computer system based on a microprocessor, a mainframe computer, a digital signal processor, a portable computing device, a device controller, or a computational engine within an appliance, to name a few.

The steps of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

Disjunctive language such as the phrase “at least one of X, Y and Z,” unless specifically stated otherwise, is to be understood with the context as used in general to convey that an item, term, etc. may be either X, Y, or Z, or a combination thereof. Thus, such conjunctive language is not generally intended to imply that certain embodiments require at least one of X, at least one of Y and at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others.

What is claimed is:

1. A portable computing device, comprising:
a display;
a memory storing an application program; and
a processor executing the application program to:
cause presentation, on the display, of a plurality of orders of restaurant menu items previously ordered by a user;
receive, from the portable computing device, a selection by the user of one of the orders, the selection indicating an intent of the user to reorder the selected order;
receive a swipe input from the user corresponding to the user swiping across the display, the swipe confirming the user's intent to reorder the selected order; and
in response to receiving the swipe input, reorder the selected order by automatically communicating the selected order over a network to a remote server operable to forward the selected order to a restaurant.

2. The portable computing device of claim 1, wherein the processor is further configured to cause presentation on the display of a carousel user interface control configured to enable the user to swipe between the plurality of orders and to perform the selection of the selected order.

3. The portable computing device of claim 2, wherein the processor is further configured to cause presentation on the display of an express reorder button superimposed over the carousel, the express reorder button being user-selectable to enable the user to initiate the reorder of the selected order.

4. The portable computing device of claim 1, wherein the processor is further configured to output a first user interface comprising the plurality of orders and to output a second user interface comprising the selected order in response to receiving, from the portable computing device, the selection.

5. The portable computing device of claim 4, wherein the second user interface comprises a swipe user interface control that receives the swipe input from the user.

6. The portable computing device of claim 5, wherein the second user interface comprises one or more images of restaurant menu items in the selected order, default order details, and the swipe user interface control below the one or more images and below the default order details.

7. The portable computing device of claim 6, wherein the default order details comprise a pickup restaurant and a pickup location in the restaurant.

8. The portable computing device of claim 7, wherein the pickup restaurant is automatically selected as a previous restaurant visited by the user if the user is within a certain range of the previous restaurant.

9. The portable computing device of claim 7, wherein the pickup restaurant is automatically selected as a closest restaurant to the user if the user is outside the certain range of the previous restaurant.

10. The portable computing device of claim 6, wherein the one or more images comprise a plurality of images horizontally laid out on the display, and wherein the display comprises an option to expand the plurality of images into a vertical list comprising the plurality of images vertically laid out on the display along with a number depicted next to each of the images and text describing each of the images.

11. A method, comprising:
under control of a hardware processor in a mobile device,
causing presentation, on a display of the mobile device, a plurality of previous sets of restaurant menu items previously ordered by a user;
receiving, from the mobile device, a first selection of a first restaurant menu item from the previous sets of restaurant menu items previously ordered by the user;
receiving a swipe input from the user corresponding to the user swiping across the display of the mobile device; and
in response to receiving the swipe input, placing an order for the first restaurant menu item by automatically communicating the order over a network so that the order is forwarded to a restaurant.

12. The method of claim 11, further comprising causing presentation on the display of an express reorder button, the express reorder button user-selectable to enable the user to provide the first selection of the first set of restaurant menu items.

13. The method of claim 11, further comprising outputting a first user interface comprising the first set of restaurant menu items previously ordered by a user and outputting a second user interface in response to receiving, from the portable computing device, the first selection of the first set of restaurant menu items.

14. The method of claim 12, wherein the second user interface comprises a swipe user interface control that receives the swipe input from the user.

15. The method of claim 13, wherein the second user interface comprises an image of the first set of restaurant menu items, default order details, and the swipe user interface control below the first set of restaurant menu items and the default order details.

16. The method of claim 15, wherein the default order details comprise a pickup restaurant and a pickup location in the restaurant.

17. The method of claim 16, wherein the pickup restaurant is automatically selected as a previous restaurant visited by the user if the user is within a certain range of the previous restaurant or as a closest restaurant to the user if the user is outside the certain range of the previous restaurant.

18. The method of claim 11, wherein the first set of restaurant menu items are depicted in pictures horizontally laid out on the display, and wherein the display comprises an option to expand the first set of restaurant items into a vertical list showing the pictures vertically aligned, a number of each item, and text describing each item.

19. Non-transitory physical computer storage comprising computer executable instructions stored thereon that, when executed by a hardware processor, configure the hardware processor to perform operations comprising:
causing presentation, on a screen of the mobile device, a set of restaurant menu items previously ordered by a user;
receiving an input from the user corresponding to the user swiping across a screen of the mobile device; and
in response to receiving the input from the user corresponding to the user swiping across a screen of the mobile device, placing an order for the set of restaurant menu items by communicating the order to a restaurant over a network.

20. The non-transitory physical computer storage of claim 19, wherein the operations further comprise automatically selecting the restaurant based on a geographic proximity of the mobile device to the restaurant.
